(19) United States
(12) Patent Application Publication
(10) Pub. No.: US 2021/0045352 A1
(43) Pub. Date: Feb. 18, 2021

(54) CUTTING HORSE TRAINING SIMULATOR

(71) Applicant: Michael W. BRIGGS, Carrollton, TX (US)

(72) Inventor: Michael W. BRIGGS, Carrollton, TX (US)

(21) Appl. No.: 16/990,761

(22) Filed: Aug. 11, 2020

Related U.S. Application Data
(60) Provisional application No. 62/885,600, filed on Aug. 12, 2019.
(60) Provisional application No. 63/041,563, filed on Jun. 19, 2020.

(51) Int. Cl. A01K 15/02; A01K 29/00; G02B 27/00; G02B 27/01

(52) U.S. Cl. CPC A01K 15/02; G02B 27/017; G02B 27/0093; A01K 29/00

(57) ABSTRACT

A digitized cutting horse training system having one or more display screens forming a video wall for display of a target animal used from training cutting horses and a controller for controlling movements of the target animal according to training animal movement data collected by one or more sensors.

### PRIORITY

The present invention claims priority to Provisional Application No. 62/885,600 filed Aug. 12, 2019 and Provisional Application No. 63/041,563 filed Jun. 19, 2020, the entirety of which is hereby incorporated by reference.

### FIELD OF INVENTION

This disclosure relates to animal training devices, and more particularly to a digitally simulated calf for use in training cutting horses.

### BACKGROUND OF THE INVENTION

Cutting horses are used in cattle herding operations to separate calves from a herd. The cutting horse rider maneuvers the calf away from the herd by approaching the calf head-on with the cutting horse, thereby forcing the calf to be removed or “cut” from the herd. Cutting horses require special training to be able to perform the cutting function. In addition, the training should be repeated periodically to keep a good cutting horse at the top of its form.

Cutting horse training is a time-consuming and expensive operation. Live calves are used for training. A cutting horse can require months or even years of training. Training a cutting horse entails in part a calf cut from the herd evading the cutting horse's attempts to direct the calf away from the herd. Calves used for cutting horse training, however, are only effective for three or four repetitions of a training session. After that, the calf loses its fear of the horse and becomes stubborn and refuses to evade the cutting horse to return to the herd. This requires the training outfit to have many, many calves on hand to adequately supply the training demand. For even moderately sized training operations this can cost several tens of thousands of dollars annually, or more because once a calf no longer fears the cutting horse, it can't be used again for training. The expense of such an operation are out of the reach of all but the most serious and well-funded cutting horse operations.

Another factor at work in the modern day cutting horse field is the fact that cattle ranches by and large no longer use cutting horses in their every day cattle operations. Now cutting operations are performed by cowboys on motor bikes or four-wheeled all terrain vehicles to gather cattle then be sorted in a pen. There is, however, an ever-growing hobby and sport use of cutting horses, with competitions being regularly held at rodeos, state fairs and the like across parts of the United States and throughout the world. It is obvious that the occasional hobbyist cannot work his horse often enough using live calves to keep his horse in top condition for shows and competitions.

Mechanical cutting horse training systems have been introduced to eliminate the need for live calves to evade riders. These mechanical systems have usually involved a flag representing a calf that is affixed to a rail, rope or wire rope. The rider of the cutting horse, through a remote controller or another non-rider operating the mechanical system, causes the flag to move from side to side on the rail, rope or wire rope at various speeds. Shortcomings of mechanical training systems such as this are many. With these training systems, the sound of the flag running on the track becomes the catalyst for the horse's movement. The problem here is that a real calf being cut from a herd does not naturally make the sound of the wheel on a track. In addition, for those mechanical flag and rail systems operated by the cutting horse rider, the horse will sense when its rider activates the remote and will come to anticipate when an abrupt flag movement will be made. Conventional training systems using flags are mechanical and are training horses to hear the sound of an electric motor or the sound of the cable movement, then to see the flag with no attributable meaning for the flag's color and then to react to the movement and direction of the flag. Further, the cutting horse rider can anticipate the horse's moves and become predictable with its control of the flag. In view of these many shortcomings with live calf and mechanical systems, there is a need for a more advanced and improved system for horse cutting training that provides enhanced training capability and is cost effective.

Thus, there presently exists a need for a cutting horse trainer that can be economically manufactured and operated. Preferably, the trainer is configured so that the operations of the calf replica may be controlled by the rider. To provide rider remote control, the controls must be simplified so that they may be manipulated while riding, with the movements of the calf being provided by relatively sophisticated program and control intelligence.

### SUMMARY OF THE INVENTION

This invention is directed to a digitized cutting horse training system comprising a virtual cow and software providing an artificial intelligence capability to effectively simulate the movements and action of a real cow in a cutting horse training environment. The system includes a series of liquid crystal display (LCD), LED, TV's Holographic or other video wall and/or futuristic type panels (collectively called the “video wall”) arranged along a partially curved wall of a cutting horse arena layout. The LCD, LED, TV's, Holographic or other video wall and/or futuristic type or other video wall type panels display video images of a cow moving as a real cow would move during cutting horse training. Associated speakers introduce the sound of cow movements in unison with the movements of the digitized cow. This combination of video and audio provide a realistic cutting horse training environment at a fraction of the cost of real calves and a far more effective training tool than present mechanical training systems.

The artificial intelligence setting of the cutting horse training simulator allows training and/or correcting the rider and horse H with the use of sounds and sensor data to maintain a correct position along path A at a substantially constant distance parallel to the virtual cow and the video wall. The simulator trains the horse to hear the sound of a cow in conjunction with a life-like virtual moving image of a cow and then react to the cow's look, movements and acts. Horses hear, then see, then react. Horses can only see colors blue and green. Horses can't see red and all other colors are seen by horses as black and white. In other embodiments, an android or robotic cow or horse can be employed in lieu of the real horse or video image or other replica of the cow.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings and photographs, wherein:

FIG. 1 depicts an overhead view of an arena according to an embodiment of the presently described cutting horse training system.

FIG. 2 depicts a front view of an arena video wall according to an embodiment of the presently described cutting horse training system.

FIG. 3 depicts a front view of an arena according to another embodiment of the presently described cutting horse training system.

FIG. 4 depicts the arena setting with a hologram projector according to an embodiment of the presently described cutting horse training system.

### DETAILED DESCRIPTION OF THE EMBODIMENTS

The detailed description set forth below is intended as a description of the present embodiments of the invention and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

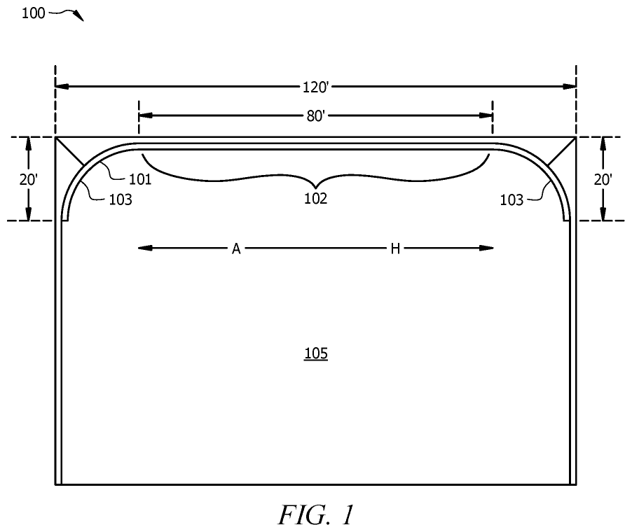

FIG. 1 depicts an overhead view of an arena according to an embodiment of the presently described cutting horse training system. In FIG. 1, arena 100 comprises video wall 101. Video wall 101 comprises a series or a single video monitor, such as LCD or LED panels, or other televisions for display of images as known in the art. Video wall is substantially flat in the center and curved at the ends. As shown, video wall 101 comprises central area 102 and curved ends 103 at each end of central area 102. Main field 105 occupies much of arena 100 to accommodate the cutting horse undergoing training or other training uses. The dimensions of arena 100 can vary. In one embodiment, arena is approximately 120 feet in width, with central area 102 of video wall 101 spanning approximately 80 feet in width. The display screens of video wall 101 are thin as are customary LED or LCD monitors or the like. Video wall 101, including curved ends 103 extends approximately twenty to thirty feet into arena 100. The depth of arena 100 can vary and the dimensions described above can vary based on the building parameters or limitations of one installing the presently described cutting horse training system.

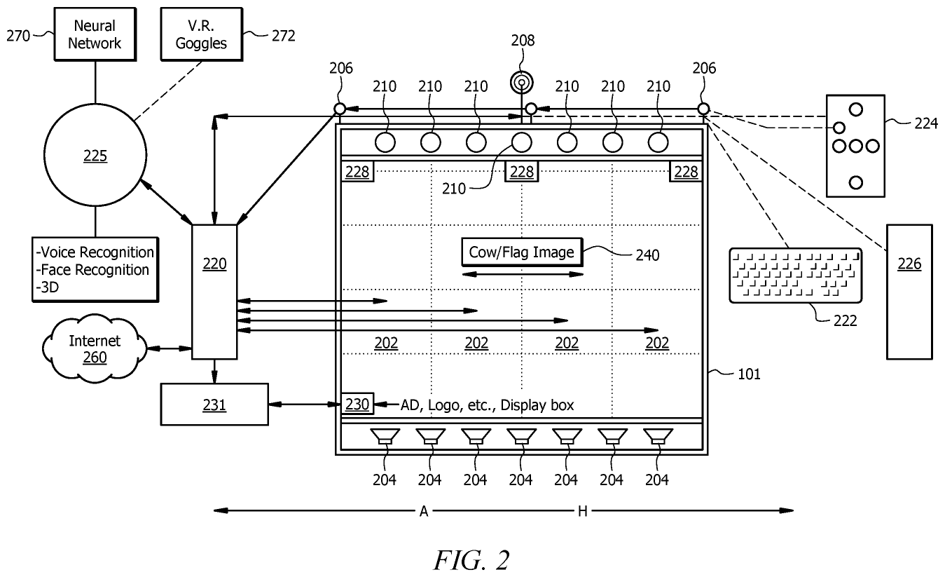

FIG. 2 depicts a front view of an arena according to an embodiment of the presently described cutting training horse. In FIG. 2, video wall 101 is comprised of a plurality of video panels 202 that are televisions, LED or LCD panels or other video wall displays as known in the art. These video walls are arranged along the width of arena 100 as shown along video wall 101 in FIG. 1. Turning back to FIG. 2, one or more speakers 204 are arranged along the length of video wall 101 beneath each video panel 202. In one embodiment speakers 204 are arranged beneath video panels 202 in order to best transmit the sound accompanying the video that is used as a training means for the cutting horse. In other embodiments, speakers 204 can be arranged elsewhere around video panels 202. Computer or other video wall controller 220 through various communicate media such as wireless, wired, Bluetooth or other means communicates video, audio and image data to panels 202.

Above video panels are one or more sensors 210. Sensors 210 can be arranged above video panels 202 as shown or can be arranged at other locations around video panels 202 and elsewhere within arena 100. Sensors 210 serve to sense the movement of the cutting horse undergoing a training session. The accompanying artificial intelligence operating software 225 residing in connection with computer 220 uses signals received from sensors 210 to cause appropriate and effective movements of the digital image of the cow or flag depicted on video panels 202. In other words, cow or flag image 240 movement is driven by cutting horse movement. Flag 240 can be blue or green in color to be more visible to the horse. Computer 220 is programmed with upgradable operating software 225 to cause movements of cow or flag image 240 in the most effective manner for training. This virtual environment provides realistic movements of the cow or flag image 240 rather than predictable or limited and redundant movements. This realism in the movements of cow or flag 240 coupled with the sounds of a cow coming from speakers 204 give the cutting horse and its rider a more realistic training experience that will prepare the cutting horse for successfully cutting a real herd, whether on a ranch or in competition.

Continuing with FIG. 2, wireless remote controller 224 is associated with computer 220 to control various features of the training system. Video wall 101 and one or more video panels can be controlled by controller 224. Controller 224 can be a hand held finger controller in communication with computer 220 to control the digital cow or flag image 240 in real time. Controller 224 can be enabled with Radio Frequency (RF), WiFi, Bluetooth or other suitable wireless protocol to wirelessly communicate with computer 220 via antenna 208 associated with video wall 101. Controller 224 can be controlled by voice commands via one or more microphones 206 associated with controller 224. Controller 224 can include voice recognition software to process voice commands received by the user. Controller 224 also provides the rider with audio instructions through one or more speakers 204. These instructions provide the rider with the ability to take corrective measures (the rider's and horse's distance and position relative to the cow or flag) to more effectively direct the cow. Antenna 208 permits wireless communication between computer 220 and controller 224 and can accommodate wireless radio, WiFi, Bluetooth or other wireless signal receiving and transmission protocols Computer 220 can be in wireless communication with video wall 101 to transmit signal to cause desired images to display on video panels 202. Computer 220 can also be in communication with video wall 101 and other peripheral devices via Wired LAN, Wireless LAN or other communication protocol. Computer 220 also communicates via a wide are network such as the Internet 260. Content can be transmitted to and from computer 220 associated with video wall 101 via Internet 260. Such content includes advertisement data that can be displayed on video wall 101 on advertisement area 230 of one or more of video panels 202. Advertisement area 230 can include advertiser names, logos, images, video or audio data and the like. Microphones 206, to receive commands from training system operators or the cutting horse rider in addition to or in lieu of controller 224, are placed on an upper side of video wall 101. Microphones can also serve to record sounds during a training session. Communications by and between the computer 220, controller 224 and the described peripheral devices can be made via USB or Ethernet wired connection, wireless radio, WiFi or Bluetooth protocols and by keystroke or voice control. Application program 226 associated with a wireless device such as a tablet, smartphone or the like (or other wearable device), provides access to the user via a such a device to an operating parameters menu for video wall 101 and the training system overall. A keyboard 222 in communication with controller 224 or computer 220 enables entry of commands and information by the user.

Computer 220, through wired or wireless connection, transmits signals to video panels 202 according to data received from sensors 210 and controller 224. Sensors are integrated into the Digital Video Signal to control the digital virtual cow's image, sound, size, speed and direction on the video wall in relationship to the horse.

Video wall 101 is customizable for each arena. Customizable help settings, training curricula and correction voice can be set. The side of the video panels employed in video wall 101 can vary depending on arena size and budget. The image of video cow 240 can be modified based on user preference. Advertising area 230 can be revenue generating for an area by displaying sponsor images, logos or other messages. The background of video wall 101 is customizable, with the operator selecting the appearance of a fence, concrete wall or the like as the backdrop.

Sensors 210 can detect the horse's position relative to the virtual cow/flag 240 and also detect the distance the horse is from video wall 101 (with a manual position and distance setting). If the horse is in the correct relative position and distance from virtual cow/flag 240, in one embodiment the cow's nose is green or an artificial voice streaming from the program through the speakers can inform the rider of the corrections needed in real time. If the horse gets too far behind virtual cow 240, the cow's sound and image speed up and then the cow attempts to get by the front of the horse to go back to the herd.

If, on the other hand, the horse gets too far ahead of virtual cow 240, the cow's sound and image stop, the cow turns in the other direction and then tries to go behind the horse to get away or go back to the herd.

If the horse gets too far from the virtual cow, the cow's sound gets fainter and the cow's image gets smaller. Then as the cow turns toward the horse the cow's nose changes color (black). When virtual cow's 240 nose turns red, the cow is lost.

If the horse gets too close to the virtual cow, the cow's sound gets louder and the image of the cow grows. Then as the cow turns away from the horse, virtual cow's 240 nose changes color (white) or an artificial voice streaming from the program through the speakers can inform the rider of the corrections needed in real time. When virtual cow's 240 nose turns red or an artificial voice streaming from the program through the speakers can inform the rider that, the cow is lost.

The primary result of the signals sent to video panels 202 is a dynamic image of flag or cow 240. The movements of flag or cow 240 are caused by movements of the cutting horse as sensed by one or more sensors 210. Sensors 210 enable measurement of speed and direction of the cutting horse and the distance between the horse and the cow. This information in turn enables computer 220 executing operating software 225 that can include artificial intelligence software to cause optimal movements of cow image 240 on video panes 202, promoting more effective training.

The premise behind training a cutting horse is for the horse to anticipate and counter evasive movements and effectively mirroring the movement of the cow/calf. When training with real livestock, the cutting horse travels in a path that would be parallel to video wall 101 and approximately from five, ten, fifteen to twenty feet into the main field 105 of arena 100. This is depicted as path A in FIG. 1, with cutting horse H traveling along path A. Between the cutting horse H and video wall 101 is the cow. The object of the cutting horse is the steer the cow in the desired direction and control the movement of the cow in the rider's desired direction. Ideally, the cow's head is aligned with the leg of the cutting horse rider. The horse is to maintain a parallel position in relation to the cow and video wall 101. In a cutting environment, if the horse advances too far along path A ahead of the cow, the cow will tend to reverse direction and escape behind the horse. Conversely, if the cutting horse lags behind the cow on path A, the cow will tend to rush ahead and escape. Once the cow advances too far ahead or retreats too far behind the cutting horse, approximately to curved ends 103 of video wall 101, then the cow is lost and the horse has failed. The training tool, therefore, is programmed to make cow, flag or replacement flag 240 evade the cutting horse and force the cutting horse rider to keep up with the cow maintaining a desired distance and direction and not advance too far ahead of or behind the cow, to prevent escape.

Speakers 204 provide the cutting horse with the real sounds of a cow's hooves and other sounds made by the cow. This is opposed to prior art training systems where the cutting horse becomes familiar with the sound of pullies or electric motors made when a mechanical flag traverses back and forth. The real sounds transmitted enable the cutting horse to better adapt and react to live cows in either a ranch setting or competitive arena.

Operating software 225 includes artificial intelligence software that includes predictive logic that serves to anticipate a cutting horse's moves and tendencies and causes image of cow or flag 240 on video panels 202 to move in a direction and manner that provides the most effective training to the cutting horse. In mechanical training systems where the cutting horse rider or third party may cause movements of the training flag, the operator's movements may become predictable or patterned, causing the horse to anticipate movements of the flag. To the contrary, in the digital training system herein described, the artificial intelligence software provides a dynamic and unpredictable training setting in which the movement of the cow or flag image 240 are randomized to provides image movements on video panels 202 that can be contrary to what might be anticipated. This provides the most effective means for training the cutting horse.

The Bluetooth or RF capability of controller 224 can have a range of 100 feet. The other wireless communication channels associated with video wall 101 and its peripherals can have a similar or greater range. The presently described cutting horse training simulator can accommodate a training run of two and one-half minutes or more. Another embodiment of the cutting horse training simulator can include a show mode in which cutting horses and riders compete and are judged by artificial intelligence (AI) using existing judging rules or other parameters The system can also include a “hot quit” feature that can correct a cutting horse from developing bad habits. This “hot quit” feature entails the rider picking his or her hand up while the cow is still moving or before the cow turns away from the cutting horse. In general, a hot quit occurs when a rider quits or gives up on a cow while the cow is facing the horse and still in motion. Ultimately, the cutting horse wants to control the cow, “squeezing” the cow's movements into a small space. The video depictions on video panels 202 can be recorded and made available for playback for additional training or entertainment. Advertisement area 230 can provide static advertisements or dynamically present advertisements that change over time or are otherwise customizable. Advertisement area 230 communicates with computer 220 via advertisement controller 231.

Software module 225 can further include programs to enable voice recognition, pace recognition and provide three dimensional imaging.

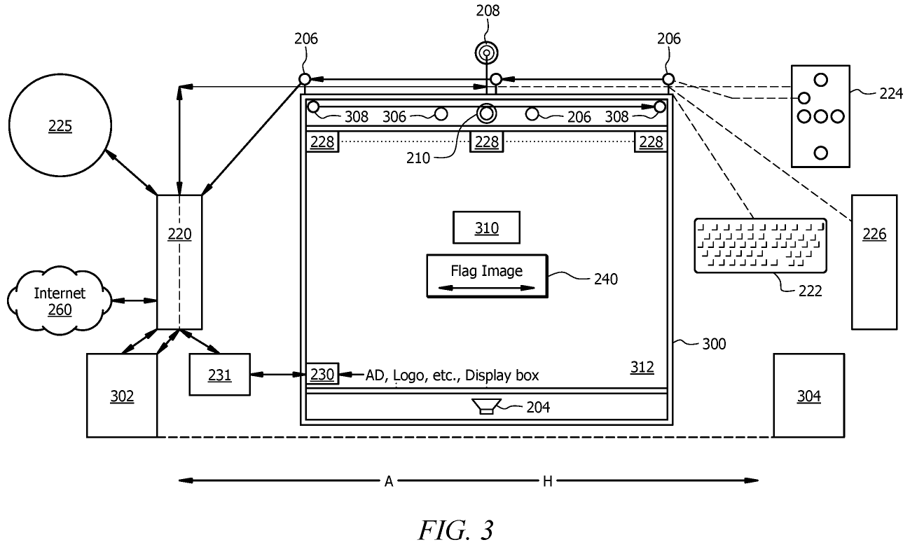

FIG. 3 depicts an alternative embodiment of the presently described cutting horse training system. In this embodiment, video display 312 and many of the accompanying components described in connection with FIG. 2 are employed to replace existing flag system 302 and existing wireless or manual flag control system 304. As shown in FIG. 3, one or more video panels 312 comprising an LED/LCD or other video display panel is installed in an existing cutting horse training area in which a mechanical flag on a rope or wire is in use. Video wall 300 can include flag hanger mounts 308 to install video display 312 on the rope or wire. Games interface 306. allows riders to participate in the show mode of the system where the riders are judged according to typical judging rules or other parameters. The video panel 312 and other components can be supplied with power from rechargeable battery 310. According to this embodiment of the training system, those trainers who have already invested in a mechanical flag system can install video wall 300 with its various components in the area dedicated to the mechanical system. This embodiment can also be installed in a pre-existing arena as a new system without a video wall. That is, video display 312 and corresponding components can be used to replace the manual flag systems, or video display 312 can be installed anew as a system with newly installed rope or wire system. In this embodiment, video display 312 does not necessarily depict the video image of a cow.

Once the embodiment of FIG. 3 is installed either as a replacement system or new system, the artificial intelligence software residing in either software module 225 in association with computer 220 or locally installed in local software module 226, which can physically reside on video display 312 in a tablet affixed to the back of video display 312, or a mobile device such as a smart phone or the like communicates with controller 224 to operate the flag. One or more application programs 226 residing on the tablet or other device provides access to an operating parameters menu that enables users to customize and use the training system herein described. In this manner, the moving video display 312 can be operated via handheld control by the rider or third party or the artificial intelligence software, through use of sensor 210, can control the action of the flag. The Video Wall, Flag and Replacement Flag described herein and shown in FIGS. 2 and 3 can be used in the Artificial Intelligent (AI) setting to compete world wide against other horses and riders in a (game, competition, tournament or show) conducted at different locations but connected through the internet or other available connection methods. These will be judged by an Artificial Intelligent (AI) judging system using a normalized set of cutting horse competition rules derived in part from existing cutting horse competition rules. These rules can be embodied in operating software 225 executed by computer 220 or other processing means.

Other features and functionality of the presently described digitized horse cutting training system include incorporation of a neural network 270. Neural networks are algorithms incorporating artificial intelligence logic modeled after the human brain and designed to recognize patterns. They interpret sensor data through machine perception, labeling or clustering raw input. Through neural network 270 similarities in data received or observed is clustered or grouped according to correlations between inputs and outputs. In the cutting horse training context, neural network 270 maps the trained cutting horse's response to a known movement of a flag or cow. Through the predictive analytics of neural network 270, a horse's tendencies and ability to anticipate the movement of the flag or cow are accounted for. As a result, the movements of the cow or flag are modified to prevent otherwise ineffective training of the horse based on predictable flag or cow movements.

Through these algorithms and programming, records of training sessions for individual horses and riders will be created and stored. Reports on progress and deficiencies will be generated automatically according to settings and parameters set for each individual horse.

A gyroscope sensor and associated programming in one embodiment is incorporated into system program to give system sensors optimal stability. A mechanical gyroscope uses a spinning rotor in the center to detect changes in orientation of the horse. A microscopic, electronic version of a vibrational gyroscope, called a MEMS gyroscope, can be employed. Accelerometers are used to detect orientation of the horse, which adds additional information or intelligence to the system to better track horse movement and detect areas for improvement.

The presently described digitized cutting horse training system in one embodiment incorporates three-dimensional technology providing three-dimensional views of the cows or flag via video wall 101. The three-dimensional imagery enabled by software associated with operating system 225 provides the horses and trainers with a more realistic training setting rather than simply a two-dimensional setting available through traditional mechanical flag training systems.

The operating system of an embodiment of the presently described digitized cutting horse training system includes mechanical controllers to control and operate existing manual flag systems. This operating system uses information gleaned from the neural network 270 to operate and control mechanical flags used in training systems.

In another embodiment, a mechanical horse is incorporated into the system. Use of a mechanical horse can serve to train cutting horse riders.

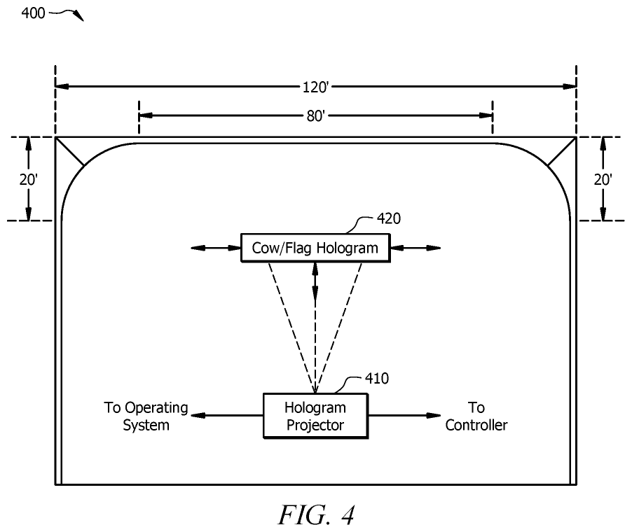

In other embodiments, a hologram depicting the imagery in lieu of the imagery displayed on the aforementioned video wall is provided. Hologram projecting equipment 410 depicted in FIG. 4 is incorporated into the described system and operates according to the operating software associated with operating system 225 to project a hologram 420 of cows or flags, with movements and action as desired. The movements of hologram 420 incorporates the artificial intelligence data through the neural network algorithms in order to provide the most effective training situations. FIG. 4 depicts the arena setting with a hologram projector 410 incorporated that is in communication with operating system 225 and one or more controllers.

In another embodiment, the presently described digitized cutting horse training system includes virtual reality goggles 272 or a headpiece for use by the horse, as shown in FIG. 2. This enhancement provides simulation of the training arena and cows and flags in lieu of the actual training venue including a video wall and display screens. Virtual goggles 272 are in wireless communication with operating system 225 that uses neural network data to transmit desired images of cows/flags to the cutting horse being trained. The neural network data and artificial intelligence capabilities are incorporated in this virtual reality goggles embodiment via wireless network capability. The desired actions and/or movement of the cows and/or flag are created virtually from the horse's perspective and the horse will respond and be trained accordingly. The virtual reality goggles 272 or headpiece is designed to comfortably fit the horse in an unobtrusive or disturbing way.

The present training system in one embodiment includes biometric capability algorithms for providing recognition of the horse based on facial features. These algorithms are associated with operating system 225 and permit detection of a specific horse according to the unique features of the horse, and in particular its face or eyes. Such unique features are digitized and a corresponding unique identifier for the horse is created. Through this biometric capability, the horse can enter a training session by being photographed or recorded by a camera. The photo or recording is compared to stored biometric data of several horses. Once matched, previously stored data corresponding to the identified horse is retrieved and loaded for a current session.

In other embodiments, an android or robotic cow or horse can be employed in lieu of the real horse or video image or other replica of the cow. An android horse can replace a real horse in order to train calves for cutting horse training use. Use of an android horse for this purpose reduces the high real cost of using cutting horses for training calves. In addition, the android horse can be used for cutting horse riding training, with artificial intelligence data leveraged to provide an optimal training setting. Riders can also control the android horse remotely in another form of competition.

Similarly, android cows can be used in lieu of video, two-dimensional or holographic cows for purposes of offering lower training cost and controllable and a more optimum training environment. The android cow can offer a more realistic training environment for the cutting horse and can be controlled to provide precise and select movements as part of the training curriculum or competition environment. Through dedicated software and leveraging artificial intelligence, the android horse and cow provide a more realistic training or competition arena through digitized modes of operation while at the same time offering a more cost effective alternative. The various features and functionality as well as implementation disclosed herein as related to the various embodiments of the cutting horse and/or the virtual cow are applicable to the android horse or cow embodiment.

The present training system in one embodiment includes voice recognition capability in order to invoke customized training programs for individual riders. Based on the recognition of the digital signature of the rider's voice, a training curriculum tailored for that rider and cutting horse is invoked. In connection therewith, the aforementioned gyroscope and sensor configuration will keep sensors focused on that rider and providing cow or flag actions to maintain proper distance and position of the horse relative to the flag or virtual cow.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious variants thereof is contemplated as falling within the spirit and scope of the disclosed inventions.

While the invention has been particularly shown and described with reference to a preferred embodiment, it will be understood by those skilled in the art that various changes in form and detail can be made therein without departing from the spirit and scope of the invention.

What is claimed is:

1. An animal training system, comprising:
a video screen wall comprising at least one video display screen;
a motion sensor for collecting movement data of a training animal;
a speaker;
a microphone;
a computer processor;
a computer program product embodied on a computer readable storage medium associated with the computer processor for processing data associated with the training animal, comprising:
computer code for receiving the training animal movement data;
computer code for generating a target animal image on the video screen wall and causing movement of the target animal image according to movement of the training animal sensed by the sensor;
computer code for generating audio emitted from the speaker according to movement of the training animal sensed by the sensor; and
wherein the movement of the target animal image causes a substantially constant distance to be maintained between the training animal and the video screen wall.

2. The animal training system of claim 1, further comprising a virtual reality headset.

3. The animal training system of claim 1, further comprising computer code for generating advertising data on the video screen wall.

4. The animal training system of claim 1, wherein the video wall comprises a central area and a first curvilinear end and a second curvilinear end.

5. The animal training system of claim 1, wherein the computer code for generating a target animal image on the video screen wall and causing movement of the target animal image according to movement of the training animal sensed by the sensor comprises a neural network algorithm.

6. The animal training system of claim 1, wherein the sensor comprises a gyroscope sensor.

7. The animal training system of claim 1, further comprising a remote controller for entering user commands to control movement of the target animal image.

8. The animal training system of claim 1, wherein the computer code for generating a target animal image on the video screen wall and causing movement of the target animal image according to movement of the training animal sensed by the sensor comprises artificial intelligence software.

9. An animal training system, comprising:
a video display screen and an image projected thereon attached to a hanger for lateral movement of the video display screen across a training arena;
a motion sensor for collecting movement data of a training animal;
a speaker;
a microphone;
a computer processor;
a computer program product embodied on a computer readable storage medium associated with the computer processor for processing data associated with the training animal, comprising:
computer code for receiving the training animal movement data;
computer code for causing movement of the video display screen and the image projected thereon according to collected movement data of the training animal;
computer code for generating audio emitted from the speaker according to movement of the training animal sensed by the sensor; and
wherein the movement of the target animal image causes a substantially constant distance to be maintained between the training animal and the video display screen.

10. The animal training system of claim 9, further comprising a virtual reality headset.

11. The animal training system of claim 9, further comprising computer code for generating advertising data on the video display screen.

12. The animal training system of claim 9, wherein the computer code for generating a target animal image on the video display screen and causing movement of the target animal image according to movement of the training animal sensed by the sensor comprises a neural network algorithm.

13. The animal training system of claim 9, wherein the sensor comprises a gyroscope sensor.

14. The animal training system of claim 9, further comprising a remote controller for entering user commands to control movement of the target animal image.

15. The animal training system of claim 8, further comprising a remote controller for entering user commands to control movement of the video display screen. The animal training system of claim 1, wherein the computer code for causing movement of the video display screen and the image projected thereon according to collected movement data of the training animal comprises artificial intelligence software.

16. An animal training system, comprising:
a representation of a target animal;
a motion sensor for collecting movement data of a training animal;
a speaker;
a microphone;
a computer processor;
a computer program product embodied on a computer readable storage medium associated with the computer processor for processing data associated with the training animal, comprising:
computer code for receiving the training animal movement data;
computer code for causing movement of the representation of the target animal according to collected movement data of the training animal;
computer code for generating audio emitted from the speaker according to movement of the training animal sensed by the sensor; and
wherein the movement of the target animal image causes a substantially constant distance to be maintained between the training animal and the representation of the target animal.

17. The animal training system of claim 16, further comprising a virtual reality headset.

18. The animal training system of claim 16, wherein the representation of the target animal is a robotic animal.

19. The animal training system of claim 16, wherein the representation of the target animal is a hologram of the target animal.

20. The animal training system of claim 16, further comprising computer code for generating advertising data on the video display screen.

21. The animal training system of claim 16, wherein the computer code for generating a target animal image on the video display screen and causing movement of the target animal image according to movement of the training animal sensed by the sensor comprises a neural network algorithm.

22. The animal training system of claim 16, wherein the sensor comprises a gyroscope sensor.

23. The animal training system of claim 16, further comprising a remote controller for entering user commands to control movement of the representation of target animal.

24. The animal training system of claim 16, wherein the computer code for causing movement of the representation of the target animal according to collected movement data of the training animal comprises artificial intelligence software.
